(19) United States
(12) Patent Application Publication
(10) Pub. No.: US 2007/0135039 A1
(43) Pub. Date: Jun. 14, 2007

(54) Apparatus and method for transmitting signal in a communication system

(75) Inventors: Byoung-Ha Yi, Seoul (KR); In-Seok Hwang, Seoul (KR); Jang-Hoon Yang, Seongnam-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/603,779

(22) Filed: Nov. 22, 2006

(30) Foreign Application Priority Data
Nov. 24, 2005 (KR) 2005-113134

(51) Int. Cl. H04B 7/15; H04B 7/00

(52) U.S. Cl. 455/11.1; 455/507

(57) ABSTRACT

A method and apparatus is provided for transmitting/receiving a signal in a base transceiver station (BTS) of a communication system. The BTS compares power of a channel quality information (CQI) signal received from a terminal with power of a CQI signal for the terminal, received from a repeater, and performs a control operation so as to transmit a signal to be transmitted to the terminal directly to the terminal or transmit the signal to the terminal via the repeater according to the comparison result.

### PRIORITY

This application claims the benefit under 35 U.S.C. § 119(a) of an application filed in the Korean Intellectual Property Office on Nov. 24, 2005 and assigned Serial No. 2005-113134, the entire contents of which are incorporated herein by reference.

### BACKGROUND OF THE INVENTION

1. Field of the Invention

The present invention relates generally to an apparatus and method for transmitting signals in a communication system, and, in particular, to an apparatus and method for transmitting signals in a communication system employing a beamforming scheme.

2. Description of the Related Art

Generally, a communication system, for example, an Institute of Electrical and Electronics Engineers (IEEE) 802.16 communication system, uses repeaters to effectively amplify and transmit weak signals in a shadow area at which electromagnetic waves from a Base Transceiver Station (BTS) cannot arrive.

FIG. 1 is a diagram schematically illustrating an operation of transmitting signals in a communication system using a BTS and repeaters. One cell has one BTS that covers the entire cell. However, because a BTS antenna is located only in the center of the cell, there occur in the cell shadow areas, such as a call insensitive area, in which electromagnetic waves can hardly arrive and an electromagnetic wave shielded area where the electromagnetic waves are shielded due to geographical obstacles. Repeaters are typically installed in the shadow areas to transmit the signals transmitted by the BTS to terminals and receive the signals transmitted by the terminals located in the shadow areas instead of the BTS, thereby preventing occurrence of shadow areas in the cell.

FIG. 2 is a diagram illustrating internal structures of a BTS and a repeater in a general communication system. Referring to FIG. 2, a BTS 200 includes a Radio Frequency (RF) signal generator 202, a down converter 204, an Analog-to-Digital (A/D) converter 206 and an optic transmitter 208. A repeater 220 includes a repeater transmitter 222, an up converter 224, a Digital-to-Analog (D/A).converter 226 and an optic receiver 228.

In the BTS 200, the RF signal generator 202 generates an RF signal to be transmitted to a terminal located in a shadow area, and outputs the generated RF signal to the down converter 204. The down converter 204 down-converts the RF signal output from the RF signal generator 202 into an Intermediate Frequency (IF) signal, and outputs the IF signal to the A/D converter 206. The A/D converter 206 converts the signal output from the down converter 204 into a digital signal, and outputs the digital signal to the optic transmitter 208. The optic transmitter 208 optically transmits the signal output from the A/D converter 206 through an optical cable.

The repeater 220 receives the optical signal from the BTS 200 using the optic receiver 228, and the D/A converter 226 converts the received digital signal into an analog signal and outputs the analog signal to the up converter 224. The up converter 224 up-converts the signal output from the D/A converter 226 into a transmission frequency signal, and outputs the transmission frequency signal to the repeater transmitter 222. The repeater transmitter 222 transmits the analog transmission frequency signal to terminals in the shadow or electromagnetic shield areas.

A process in which the BTS 200 receives signals from a terminal located in the shadow area is opposite to the process described above. In this process, it is preferable that the transmitter serves as a receiver, the up converter and the down converter serve as a down converter and an up converter, and the A/D converter and the D/A converter serve as a D/A converter and an A/D converter, respectively.

The IEEE 802.16 communication system uses a beamforming scheme to increase the throughput and to widen the cell coverage. The term “beamforming scheme” refers to a scheme in which a signal transmission apparatus, for example, a BTS, applies a weight to each of its antennas for the signal to be transmitted to a signal reception apparatus, for example, terminal before transmission of the signal, thereby directing the full beam to the target terminal. In this way, the beamforming scheme increases the throughput and broadens the cell coverage of the entire communication system.

However, even though the beamforming scheme is applied, there can occur in the cell a call insensitive area at which electromagnetic waves hardly can arrive and an electromagnetic wave shielded area where the electromagnetic waves are shielded due to geographical obstacles. Therefore, in order to effectively amplify and repeat weak signals in the shadow areas at which electromagnetic waves of the BTS cannot arrive, even though the communication system uses the beamforming scheme, system will use repeaters.

However, where the repeater operating method generally used in the current communication system is simply applied to a communication system employing the beamforming scheme, if the signal transmitted by the BTS and the signal transmitted by the repeater are simultaneously received at the terminal, problems may occur. A description thereof will be made hereinbelow with reference to FIG. 3.

As illustrated in FIG. 3, the signal from the BTS is a beamformed signal to which the beamforming scheme is applied according to channel environment between a BTS antenna and a terminal, while the signal from the repeater is a broadcast signal to which the beamforming scheme is not applied. Therefore, because the broadcast signal from the repeater is not taken into consideration in the process of applying the beamforming scheme, the signal from the BTS and the signal from the repeater may interfere with each other, unexpectedly causing degradation of the entire performance of the communication system.

### SUMMARY OF THE INVENTION

It is, therefore, an object of the present invention to provide an apparatus and method for transmitting/receiving signals in a communication system employing a beamforming scheme.

It is another object of the present invention to provide an apparatus and method for transmitting/receiving signals using repeaters in a communication system employing a beamforming scheme.

According to one aspect of the present invention, there is provided a method for transmitting/receiving a signal in a base transceiver station (BTS) of a communication system. The method includes comparing power of a channel quality information (CQI) signal received from a terminal with power of a CQI signal for the terminal, received from a repeater and performing a control operation so as to transmit a signal to be transmitted to the terminal directly to the terminal or transmit the signal to the terminal via the repeater according to the comparison result.

According to another aspect of the present invention, there is provided an apparatus for transmitting/receiving a signal in a communication system. The apparatus includes a Base Transceiver Station (BTS) for comparing power of a Channel Quality Information (CQI) signal received from a terminal with power of a CQI signal for the terminal, received from a repeater, and performing a control operation so as to transmit a signal to be transmitted to the terminal directly to the terminal or transmit the signal to the terminal via the repeater according to the comparison result.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating an exemplary operation of a transmitting signals in a communication system using a BTS and repeaters;

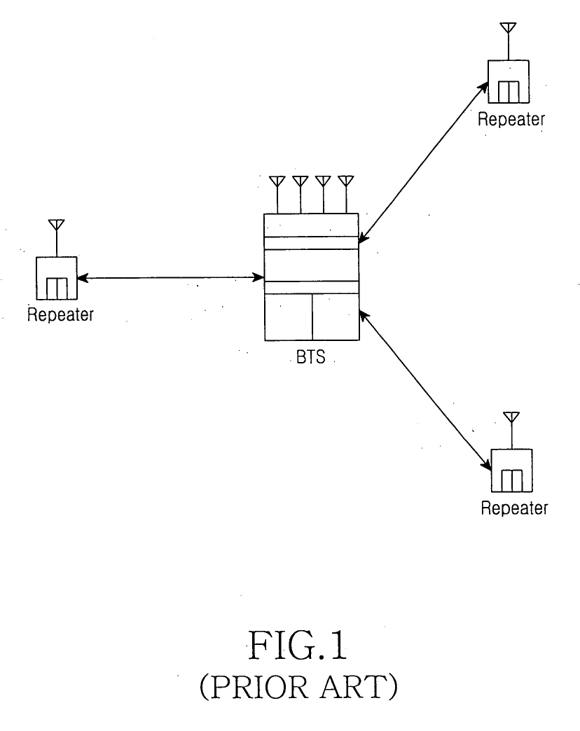

FIG. 2 is a diagram illustrating structures of a BTS and a repeater, given for a description of a signal exchange process between the BTS and the repeater;

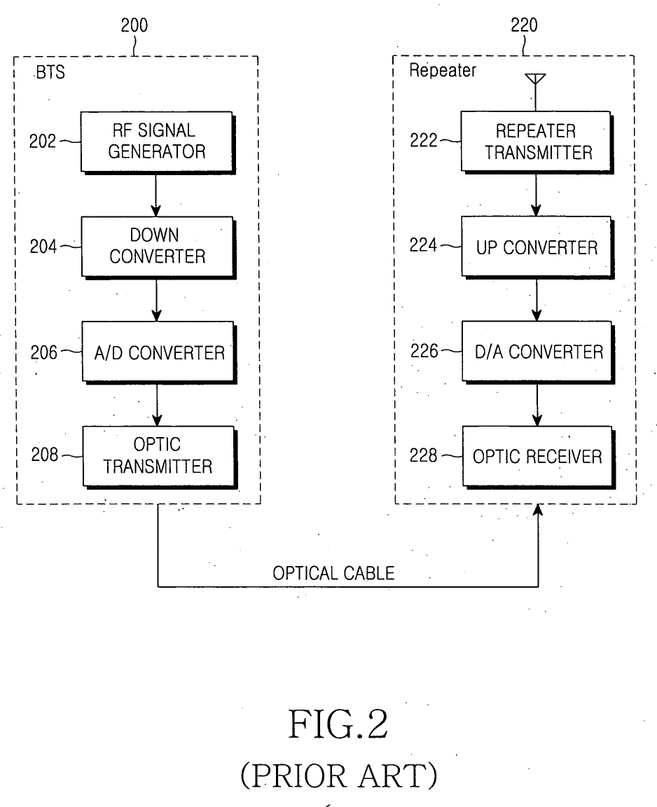

FIG. 3 is a diagram for a description of beamforming between a BTS and a repeater; and

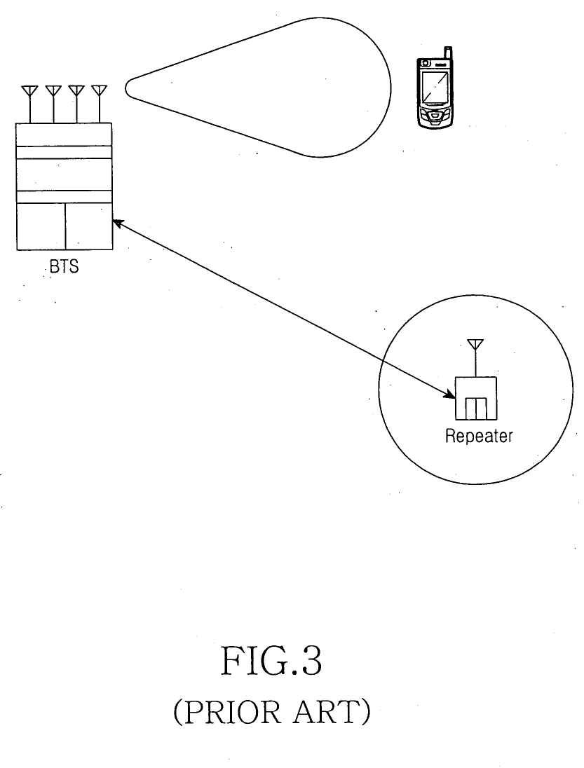

FIG. 4 is a flowchart illustrating a data exchange process between a terminal, a repeater, and a BTS in an OFDMA system employing beamforming according to the present invention.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

According to the present invention, in the communication system using an Orthogonal Frequency Division Multiple Access (OFDMA) scheme (OFDMA communication system) like an Institute of Electrical and Electronics Engineers (IEEE) 802.16 communication system, terminals transmit Channel Quality Information (CQI) to a Base Transceiver Station (BTS) for a reverse interval. That is, each of the terminals receiving service from the BTS transmits its own forward CQI information to the BTS for the reverse interval. Then, the CQI signal directly transmitted from the terminal and the CQI signal transmitted via a repeater are received at the BTS. Therefore, the present invention provides an apparatus and method for allowing the BTS to periodically compare the signals received through the two different paths, determine whether a signal valid for each terminal was directly received from the terminal or was received via a repeater, and transmit the signal only to the transmitter (terminal or repeater) for which the signal was determined to be valid.

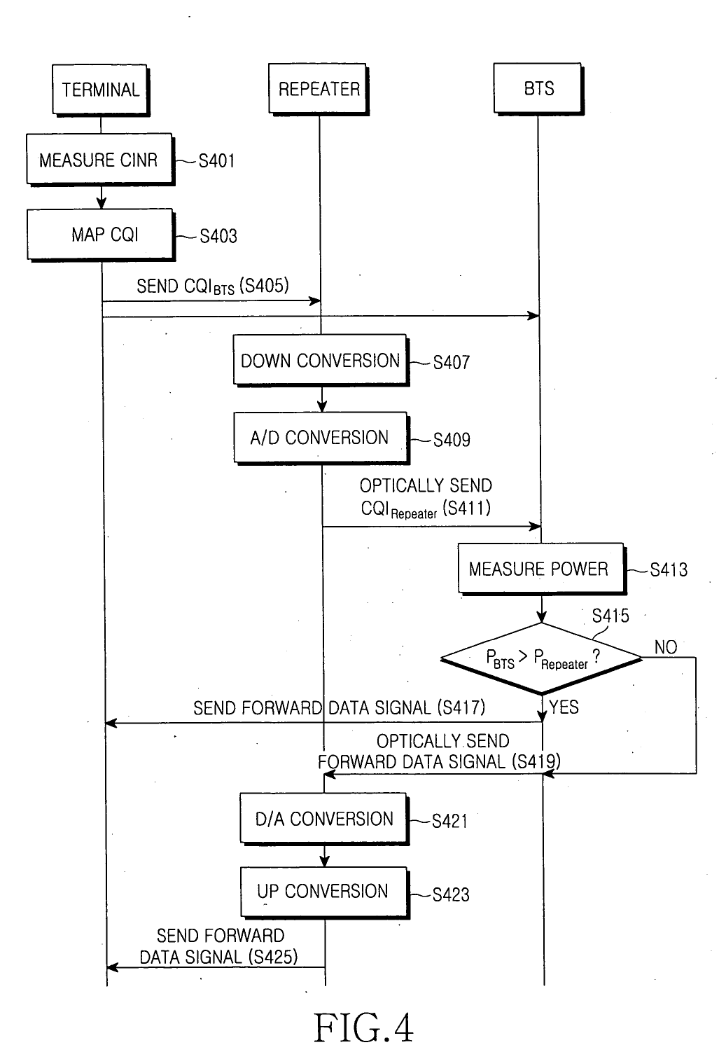

FIG. 4 is a flowchart illustrating a signal exchange process between a terminal, a repeater, and a BTS in an OFDMA communication system employing a beamforming scheme according to the present invention. Referring to FIG. 4, a terminal measures a Carrier-to-Interference and Noise Ratio (CINR) for a forward signal received from a BTS in step S401. The terminal maps a corresponding CQI to the measured CINR in step S403. The terminal modulates the mapped CQI and transmits the modulated CQI to the BTS and a repeater in step S405. The CQI signal transmitted at this time will be referred to as “CQI_{BTS}.”

Then the repeater down-converts the CQI signal received from the terminal into an Intermediate Frequency (IF) signal in step S407, converts the down-converted CQI signal into a digital signal in step S409, and optically transmits the digital signal to the BTS through an optic transmitter in step S411. The CQI signal transmitted at this time will be referred to as “CQI_{Repeater}.”

Then the BTS measures power of the CQI_{BTS} received from the terminal and the CQI_{Repeater} received from the repeater in step S413. Herein, the power of the CQI_{BTS} will be referred to as P_{BTS}, and the power of the CQI_{Repeater} will be referred to as P_{Repeater}.

The BTS compares the P_{BTS} with the P_{Repeater} in step S415. If P_{BTS} is greater than P_{Repeater,} the BTS prevents the repeater from repeating the corresponding signal, and only the BTS transmits the forward signal in step S417.

However, if P_{BTS} is less than or equal to P_{Repeater}, the BTS optically transmits the forward signal transmitted to the terminal, to the repeater to which the corresponding terminal belongs, through the optic transmitter in step S419. Upon receiving the optically transmitted forward signal, the repeater converts the received forward signal into an analog signal in step S421, up-converts the analog forward signal into a transmission frequency signal in step S423, and then transmits the transmission frequency signal to the corresponding terminal in step S425.

In FIG. 4, if the CQI signal is replaced with an initial ranging signal during initial access of the terminal, or is replaced with a handoff ranging signal during handoff of the terminal, the entities of transmitting the forward signal during initial access and handoff of the terminal can be determined as done in the process described in FIG. 4.

Although the repeater connected to the BTS via the optical cable is used herein, those of skill in the art will recognize that a relay can also be used instead of the repeater, and the repeater is either fixable or movable.

As can be understood from the foregoing description, the communication system employing the beamforming scheme uses only the beamforming scheme or the repeater according to the CQI, thereby increasing the throughput and extending the cell coverage of the system. In this manner, the present invention can improve the signal quality for the call insensitive area or the electromagnetic wave shielded area.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting/receiving a signal in a Base Transceiver Station (BTS) of a communication system, the method comprising:
comparing power of a Channel Quality Information (CQI) signal received from a terminal with power of a CQI signal for the terminal, received from a repeater; and
performing a control operation so as to transmit a signal to be transmitted to the terminal directly to the terminal or transmit the signal to the terminal via the repeater according to the comparison result.

2. The method of claim 1, wherein performing a control operation comprises directly transmitting the signal to the terminal, if the power of the CQI signal received from the terminal is higher than the power of the CQI signal received from the repeater.

3. The method of claim 2, wherein directly transmitting the signal to the terminal comprises directly transmitting the signal to the terminal using a beamforming scheme.

4. The method of claim 1, wherein performing a control operation comprises transmitting the signal to be transmitted to the terminal to the terminal via the repeater, if the power of the CQI signal received from the terminal is lower than or equal to the power of the CQI signal received from the repeater.

5. An apparatus for transmitting/receiving a signal in a communication system, the apparatus comprising:
a Base Transceiver Station (BTS) for comparing power of a Channel Quality Information (CQI) signal received from a terminal with power of a CQI signal for the terminal, received from a repeater, and performing a control operation so as to transmit a signal to be transmitted to the terminal directly to the terminal or transmit the signal to the terminal via the repeater according to the comparison result.

6. The apparatus of claim 5, wherein the BTS directly transmits the signal to the terminal, if the power of the CQI signal received from the terminal is higher than the power of the CQI signal received from the repeater.

7. The apparatus of claim 6, wherein the BTS directly transmits the signal to terminal using a beamforming scheme.

8. The apparatus of claim 5, wherein the BTS directly transmits the signal to the terminal via the repeater, if the power of the CQI signal received from the terminal is lower than or equal to the power of the CQI signal received from the repeater.
